(19) United States
(12) Patent Application Publication
(10) Pub. No.: US 2001/0014386 A1
(43) Pub. Date: Aug. 16, 2001

(54) Wood wool construction element and method for its manufacture

(75) Inventors: Manfred Doppelreiter, Spittal (AT); Willibald Neuherz, Ferndorf (AT); Gunter Moser, Villach (AT)

Correspondence Address: Mark Kusner, Mark Kusner Co., LPA, Highland Place - Suite 310, 6151 Wilson Mills Road, Highland Heights, OH, 44143, US

(73) Assignee: Osterreichische Heraklith GmbH

(21) Appl. No.: 09/759,927

(22) Filed: Jan. 12, 2001

(30) Foreign Application Priority Data
Feb. 10, 2000 (DE) 100 06 041.2

(51) Int. Cl. B32B 5/24

(52) U.S. Cl. 428/311.11; 428/311.51; 428/317.9; 428/920

(57) ABSTRACT

The invention relates to a wood wool construction element and a method for its manufacture.

### DESCRIPTION

The invention relates to a wood wool construction element and a method for its manufacture.

The term construction element refers in this connection to any type of a shaped product, for example, a board. Wood wool light construction boards have been known under the trade name “Heraklith” for a long time. The wood wool fibers have conventionally a length of more than 8 cm, a width of 3 to 6 mm, and a thickness of 0.2 to 0.5 mm. The brittle wood wool fibers which are present in irregular geometry are positioned within the construction element in the form of open-pore, three-dimensional structures in an irregular distribution pattern and are at least over portions thereof connected by a binding agent, for example, magnesia binding agent.

According to DIN 4102, such construction parts are divided into A—non-combustible components—with the subclasses A1—materials which do not combust at all—and A2—materials which are only slightly combustible but do not maintain a fire—. The further division according to DIN 4102 is as follows: B—combustible materials—wherein this class is again divided into B1—components that are weakly flammable—, B2—ordinary flammable components—and B3—easily flammable components—.

The afore described known wood wool light construction board is classified in class B1.

The afore described known wood wool light construction board is classified in class B1.

The present invention has the object to provide wood wool construction elements which provide an increased fire protection and which can be classified in class A2 according to DIN 4102.

Experiments to admix a flame retardant to the binding agent during manufacture of the wood wool construction elements have not led to satisfying results. Also, by spraying a liquid flame retardant onto the wood wool fibers the desired flammability class A2 could not be achieved.

On the other hand, wood wool construction elements of the class A2 (according to DIN 4102) were obtained by employing wood wool fibers which are soaked in (completely impregnated with) a flame retardant.

Accordingly, the invention in its most general embodiment relates to a wood wool construction element with the following features:

an open-pore, three-dimensional structure of irregularly distributed wood wool fibers, wherein

the wood wool fibers

at least over portions thereof are connected with one another by a binding agent and

are soaked in a flame retardant.

For manufacturing such wood wool construction elements the invention in its most general embodiment provides the following method:

wood wool fibers are soaked in a flame retardant solution,

after the soaking the thus impregnated wood wool fibers are, at least over portions thereof, coated with a binding agent,

are processed to construction elements, and

are kept in their mold until the binding agent has cured and the construction element is shape-stable.

It was surprisingly found that the type of application of the flame retardant has a decisive effect on the obtainable flammability class. When a (complete) soaking of the (raw) wood wool fibers with a flame retardant solution is carried out, construction elements can be produced which exhibit a fire protection effect which is greater by up to 60% in comparison to construction elements in which the flame retardant is provided in or on the binding agent (for example, a binding agent suspension).

The manufacture, in particular, the shaping of the construction elements, can be carried out by the way in a manner known to person skilled in the art. For this purpose, the fibers coated with the binding agent can be placed into a mold and compressed (pressed) wherein the elements are kept in their mold until the binding agent has cured and the element is shape-stable.

Another manufacturing technique is described in EP 0 655 991 B1. Here, the wood wool fibers (after soaking in the flame retardant solution) are processed to construction elements and, during the processing (shaping), the wood wool fibers are encrusted with a binding agent foam.

A possible binding agent is comprised, by the way, of a binding agent suspension which is sprayed onto the wood wool fibers or into which the wood wool fibers are placed for a corresponding coating. The binding agent can be a magnesia binding agent, for example, a MgO caustic suspension.

Construction elements of a raw density between, for example, 200 and 700 kg/m can be produced.

The proportion of the flame retardant can be, relative to the wood wool fibers, 5 to 50% by weight, according to one embodiment 10 to 40% by weight, wherein the proportion of 25 to 35% by weight is often sufficient to achieve the desired flammability class. This depends, inter alia, on the type of the wood, the size of the wood wool fibers, the type of the flame retardant or the concentration of the corresponding flame retardant solution.

The flame retardant can be, for example, ammonium phosphate, ammonium poly phosphate, ammonium sulfate, tri sodium phosphate, hexameta phosphate, dipentaerythritol, alone or in mixtures with different proportions.

Solutions of the aforementioned flame retardant can be used in concentrations between 5 and 50%, typically in concentrations of 25 to 35%, wherein aqueous solutions can be used. The viscosity of such a solution at 20° C. is, for example in the magnitude of 0.01 P (dPas).

The proportion of binding agent, relative to the wood wool fibers impregnated with the flame retardant, is typically in the range of 10 to 40% by weight, according to one embodiment in the range of 15 to 30% by weight.

The proportion depends, inter alia, on the desired strength class as well as the proportion of open pores (free spaces between the wood wool fibers).

In this connection, the aforementioned quantity data for the binding agent, which is not limited to magnesia binding agent but can be, for example, also Portland cement (or a corresponding suspension), relate to the soaked wood wool fibers in the dried state.

With respect to the method for manufacturing, this means that the wood wool fibers, after soaking with the flame retardant and before coating with the binding agent, can be dried.

Further features of the invention result from the features of the dependent claims as well as the other application documents.

In the following, the invention will be explained in more detail with the aid of one embodiment.

In this connection, the wood wool fibers of the aforementioned kind and size are soaked for three minutes in a 30% by weight aqueous solution of ammonium phosphate. As a result of the open porosity of the wood wool fibers, a complete soaking of the wood wool fibers with the flame retardant will occur within this time period.

Subsequently, the fibers soaked in this way are dried, then encrusted with a MgO caustic suspension at their surface, placed into a mold box which is open at the top and has a rectangular base surface, and compressed from above by a plunger to the desired board thickness. Subsequently, the plunger is again removed. The formed board remains in the mold box until the binding agent (the MgO caustic suspension) has cured and the board is shape-stable. Subsequently, the board is removed from the mold and transferred to a shelf for final drying.

The board manufactured in this way fulfills the flammability class A2 in a test.

In further fire behavior tests, the coking enhancing effect of the flame retardant could be proven. Directly after starting of the fire behavior test, a thin carbon layer forms on the wood wool fibers and protects them against a (further) oxidative decomposition. At the same time, the flame is at least partially extinguished.

1. A wood wool construction element having the following features:
1.1 an open-pore, three-dimensional structure of irregularly distributed wood wool fibers, wherein
1.2 the wood wool fibers
1.2.1 at least over portions thereof are connected with one another by a binding agent and
1.2.2 are soaked with a flame retardant.

2. The construction element according to claim 1, having a raw density between 200 and 700 kg/m³.

3. The construction element according to claim 1, wherein the proportion of the flame retardant, relative to the wood wool fibers, is 5 to 50% by weight.

4. The construction element according to claim 1, wherein the proportion of the flame retardant, relative to the wood wool fibers, is 10 to 40% by weight.

5. The construction element according to claim 1, wherein the proportion of the flame retardant, relative to the wood wool fibers, is 25 to 35% by weight.

6. The construction element according to claim 1, wherein the flame retardant is comprised of ammonium phosphate, ammonium poly phosphate, ammonium sulfate, tri sodium phosphate, hexameta phosphate, dipentaerythritol or mixtures thereof. ammonium phosphate, ammonium poly phosphate, ammonium sulfate, tri sodium phosphate, hexameta phosphate, dipentaerythritol or mixtures thereof.

7. The construction element according to claim 1, wherein the proportion of the binding agent, relative to the wood wool fibers soaked with the flame retardant, is 10 to 40% by weight.

8. The construction element according to claim 1, wherein the proportion of the binding agent, relative to the wood wool fibers soaked with the flame retardant, is 15 to 30% by weight.

9. The construction element according to claim 1, wherein the binding agent is an inorganic binding agent.

10. The construction element according to claim 1, wherein the binding agent is a magnesia binding agent.

11. A method for manufacturing a wood wool construction element comprising the steps of:
11.1 wood wool fibers are soaked in a flame retardant solution,
11.2 after drying the thus soaked wood wool fibers are, at least over a portion thereof, coated with a binding agent,
11.3 are processed to construction elements, and
11.4 are kept in their mold until the binding agent has cured and the construction element is shape-stable.

12. The method according to claim 11, wherein the wood wool fibers are soaked in an aqueous flame retardant solution.

13. The method according to claim 11, wherein the wood wool fibers are soaked in the flame retardant solution until the weight of the wood wool fibers has increased by 5 to 50% by weight.

14. The method according to claim 11, wherein the wood wool fibers are dried after soaking with the flame retardant and before coating with the binding agent.

15. The method according to claim 11, wherein the wood wool fibers, after soaking with the flame retardant agent, are encrusted with a binding agent suspension at their surface and are subsequently processed to construction elements.

16. The method according to claim 11, wherein the wood wool fibers, after soaking with the fire protection agent, are processed to construction elements and the wood wool fibers are encrusted with a binding agent foam during processing.
